(19) United States
(12) Patent Application Publication
(10) Pub. No.: US 2009/0102858 A1
(43) Pub. Date: Apr. 23, 2009

(54) VIRTUAL SPOTLIGHT FOR DISTINGUISHING OBJECTS OF INTEREST IN IMAGE DATA

(75) Inventors: Helmuth Eggers, Sindelfingen (DE); Stefan Hahn, Ulm (DE); Gerhard Kurz, Wendlingen (DE); Otto Loehlein, Illerkirchberg (DE); Matthias Oberlaender, Ulm (DE); Werner Ritter, Ulm (DE); Roland Schweiger, Ulm (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/293,364

(22) PCT Filed: Mar. 12, 2007
(86) PCT No.: PCT/EP2007/002134

§ 371 Date: Sep. 17, 2008

(30) Foreign Application Priority Data
Mar. 17, 2006 (DE) 10 2006 012 773.0
Oct. 6, 2006 (DE) 10 2006 047 777.4

(51) Int. Cl. G09G 5/00

(52) U.S. Cl. 345/617

(57) ABSTRACT

Assistance systems are increasingly being used to assist vehicle drivers when driving their vehicles. To this end, a camera is used to record image data from the area surrounding a vehicle, and at least some of the image data (1) are shown on a display following object identification and image processing. After the image data have been recorded by the camera, they are processed using object identification in order to identify objects (2, 3) in the recorded image data. At least some of the objects (2, 3) which have been identified in this manner are highlighted when showing the image data (1) on the display. In this case, the identified objects (2, 3) are highlighted in such a manner that the image data (1) to be shown are divided into two types of regions. In this case, the first type of region comprises the objects (2, 3) which have been identified and are to be highlighted and a surrounding region (2a, 3a) which respectively directly adjoins the latter in a corresponding manner. The second type of region then comprises those image data (1) which have not been assigned to the first type of region. The objects in the image data (1) are then highlighted in such a manner that the image data of both types of regions are manipulated in different ways.

The invention relates to a method for highlighting objects in image data, and to an image display which is suitable for this purpose as per the preamble of patent claims 1 and 25.

In order to assist the drivers of vehicles when they are driving their vehicles, assistance systems are increasingly being used which acquire image data on the surroundings of the vehicle by means of camera systems and display said data on a display. In particular, in order to assist the drivers of vehicles when traveling at night, what are referred to as night vision systems are known which significantly extend the region which can be seen by the driver of the vehicle beyond the region which can be seen using the dipped headlights. In this context, image data on the surroundings are acquired in the infrared wavelength range and displayed to the driver. Since these image data originating from the infrared wavelength range are not immediately accessible to a driver of a vehicle as a result of their unusual appearance, it is appropriate to condition these image data by means of image processing systems before they are presented.

In order to attract a driver's attention to a pedestrian, German laid-open patent application DE 101 31 720 A1 describes that a head-up display in the field of vision of the driver is used to include a representation of a pedestrian at the pedestrian's location in the surroundings of the vehicle. In order to highlight the pedestrian in particular, it is also proposed to include a frame around the symbolic representation.

However, in order to avoid overlapping between relevant details as a result of the image information being superimposed in symbolic form, it is also conceivable to manipulate the image data of relevant objects by means of image processing before said data are displayed. For example, German laid-open patent application DE 10 2004 034 532 A1 proposes highlighting relevant objects in terms of their brightness or coloring in the resulting image representation by manipulating the image data. In addition, German laid-open application DE 10 2004 028 324 A1 describes highlighting objects, in particular living beings, in the image data by enhancing the contour.

In order also to increase the distinguishability of objects which are highlighted in the image data in this way, German laid-open patent application DE 102 59 882 A1 additionally proposes subjecting the objects to a type classification before the color manipulation of the image data and coloring said objects in a type-specific manner on this basis.

The object of the invention is to find a method and an image display which is suitable for carrying out the method which permit the highlighting of relevant objects in image data to be improved further.

The object is achieved by means of a method and an image display suitable for carrying out the method having the features of patent claims 1 and 17. Advantageous developments and refinements of the invention are described with the subclaims.

In the method for displaying images image data from the surrounding area a vehicle are recorded by means of a camera, and at least some of the image data (1) are displayed on a display after object identification and image processing. After the recording of the image data by means of the camera, said image data are processed by means of an object identification device in order to identify objects (2, 3, 4, 5) in the recorded image data. At least some of the objects (2, 3, 4, 5) which are identified in this way are highlighted on the display when the image data (1) are displayed. Here, the highlighting of the identified objects (2, 3, 4, 5) is carried out inventively in such a way that the image data (1) which are to be displayed are divided into two types of regions. In this context, the first type of region comprises the identified objects (2, 3, 4, 5) which are to be highlighted and a surrounding region (2a, 3a, 4a) which respectively directly adjoins said objects in a corresponding manner. The second type of region then comprises those image data (1) which have not been assigned to the first type of region. The highlighting of the objects in the image data (1) is then carried out in such a way that the image data of the two types of region are manipulated in different ways.

In contrast to the prior art, in which the image data of the objects which are to be highlighted are either replaced by symbolic representations or else the image data which can be directly assigned to the object are specifically manipulated (improvement of contrast or changing of color), the objects (2, 3, 4, 5) are highlighted in a particularly advantageous way by virtue of the fact that not only the object as such but rather in addition also the directly adjoining image region is highlighted. This combination results in an image region of the first type which is subsequently treated in a uniform, inventive manner. Through joint treatment of an object with the directly adjoining surrounding region, the impression of virtual illumination of the object and of its direct surroundings (flashlight effect) is produced by highlighting in the image data in a way which is advantageous for the person viewing the image display. For example, this permits the objects to be highlighted to be perceived in an extremely intuitive way, in particular in night scenes.

A further advantage is obtained in that although the relevant objects which are to be highlighted have to be identified in the image data which are recorded by the camera, the object contour of said objects does not have to be determined precisely. This is because the image regions of the first type are not only assigned to the objects but also to their direct surrounding region. Given suitable dimensioning of these direct surrounding regions, it is generally ensured that the objects are highlighted to their full extent even if the object identification algorithm from the image processing system was not able to extract the object from the image scene in its entire dimensions; this is frequently the case in particular for complex objects such as pedestrians in poorly illuminated scenes with poor image contrast.

The invention will be explained in detail below using figures, of which:

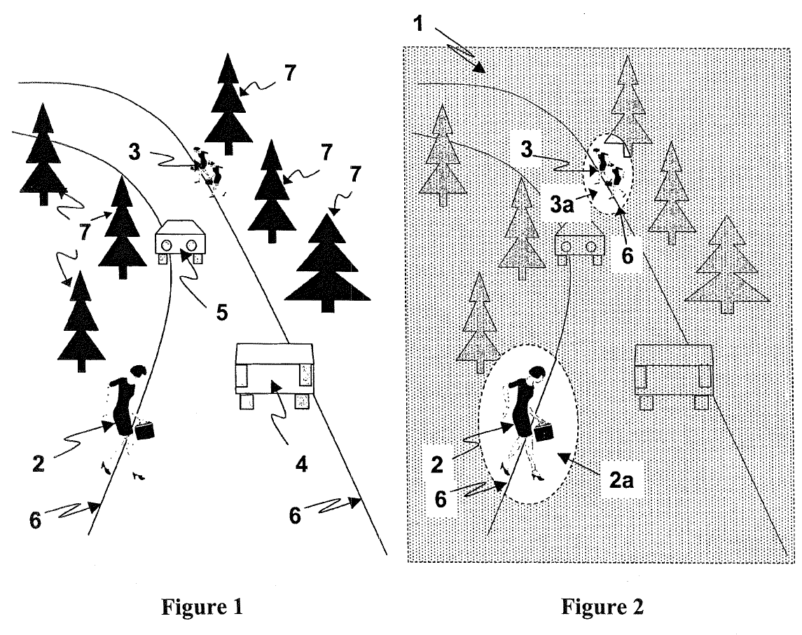

FIG. 1 shows a traffic scene in front of a vehicle,

FIG. 2 shows the image data (1) of the traffic scene from FIG. 1, after object identification has been carried out and the image regions of the first type which contain pedestrians (2, 3) have been highlighted,

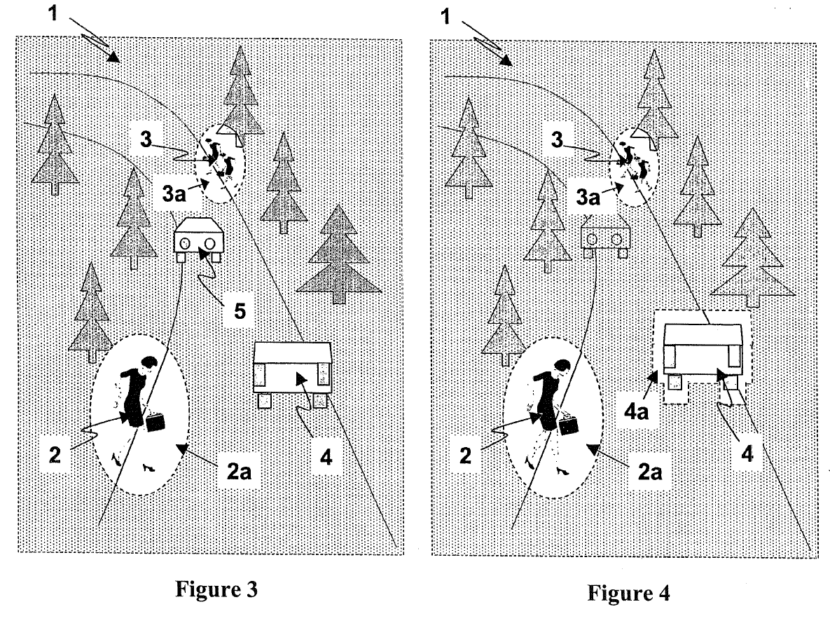

FIG. 3 shows the image data (1) of the traffic scene from FIG. 1, after object identification has been carried out and the image regions of the first type which contain pedestrians (2, 3) and image regions of the third type which comprise vehicles (4, 5) have been highlighted, and

FIG. 4 shows the image data (1) of the traffic scene from FIG. 1, after object identification has been carried out and the image regions of the first type which contain pedestrians (2, 3) and a further image region of the first type which contains the vehicle (4) which is traveling in front have been highlighted.

FIG. 1 illustrates a typical traffic scene in front of a motor vehicle, such as can be observed by the driver of a vehicle while he looks through the windshield, or such as can be acquired by the camera which is assigned to the image processing system according to the invention. The traffic scene comprises a road which has lane boundaries (6). Along the course of the road there are a number of trees (7) in its surroundings. On this road there is a vehicle (4) which is traveling in front or is parked in front of the driver's vehicle on the roadway, while a vehicle (5) which is coming in the opposite direction to the driver's vehicle is located on the opposite lane. Furthermore, the traffic scene comprises a person (2) who is moving onto the roadway from the left in the foreground of the scene, as well as a group of people (3) who are moving onto the roadway from the right at a greater distance, in the region of the groups of trees. The observation of this traffic scene by the driver of the vehicle requires a high degree of attention since a number of different objects have to be perceived and observed; this is already extremely demanding, for example, in view of the group of people (3) located at a greater distance, in the region of the trees (7). However, in addition, the driver of the vehicle is also required to estimate the relevance of the objects in terms of hazard as a function of their position and movement in relation to the driver's own vehicle.

In order to relieve the loading on the driver of the vehicle when performing this task, it is therefore appropriate to capture the traffic scene by means of a camera system and to process and condition the image data acquired in this way so that said data, when displayed on a display, facilitate the capturing of the traffic scene. In this context it is appropriate to select the objects in the image data which are to be particularly taken into consideration and to display them in a highlighted fashion within the scope of the representation. Such conditioned image data (1) of the traffic scene which is represented in FIG. 1 are shown in FIG. 2. The image data which is acquired from the traffic scene by means of a camera were subjected here to object classification by means of which pedestrians (2, 3) included in the traffic scene have been identified so that they could be displayed in a highlighted fashion in the represented image data together with the direct surrounding regions (2a, 3a) of said image data.

Of course, the object classification can be oriented at the identification of further objects or of other objects depending on the field and purpose of application. For example it would be conceivable also to identify, in addition to the pedestrians, vehicles which are located on the roadway, and within the scope of other fields of application the objects to be identified could, however, also be road signs or pedestrian crossings. On the other hand, the identification and/or classification of objects can also be configured in such a way that the directions and speeds of movement of the objects are also taken into account so that, for example, a person who is located at a greater distance and is moving away from the roadway is no longer selected and highlighted in the display.

As is shown more clearly in FIG. 2, the objects (2, 3) which are identified by means of the object classification device and are to be highlighted within the scope of the display are respectively assigned to their directly surrounding region (2a, 3a) so that two regions of the first type are produced, which are then treated or manipulated differently from the remaining image data (image regions of the second type) in order to highlight them.

In order to bring about highlighting of the image regions of the first type when displaying the image data, it is then possible, on the one hand, to make the image data which are assigned to these image regions brighter. However, on the other hand, highlighting of the image regions of the first type can also be brought about by reducing the intensity of the image regions of the second type. This corresponds to the image data (1) illustrated schematically in FIG. 2. When a comparison is made with the intensity levels from the traffic scene illustrated in FIG. 1, it is apparent that the intensity of the objects (2, 3) and of the image region (2a, 3a) directly surrounding them has been kept constant while the intensity, and therefore perceptibility, of the other image regions has been significantly decreased. This results in highlighting of the image regions of the first type, as it were by virtue of the fact that a type of dark veil is placed over the remaining image regions. Depending on the respective fields of application and purpose of application, it may, however, be advantageously appropriate both to increase the brightness of the image regions of the first type and to reduce the intensity of the image regions of the second type simultaneously.

From FIG. 2 it is also apparent that the additional highlighting of the region (2a, 3a) directly surrounding the relevant objects (2, 3) also particularly advantageously results in highlighting of other detail information which is useful in assessing the traffic scene; here the display of the edge of the road in the highlighted image region of the first type. If, as described in the prior art, only the object (2, 3) itself is highlighted from the image data, this detail in the surroundings which is also important for assessing the traffic situation actually moves into the background so that it also becomes more difficult for the driver of the vehicle to perceive it.

The manipulated image data (1) of the traffic scene which is displayed to the driver of the vehicle by means of the image display can also be rendered perceptible by virtue of the fact that these image regions are at least simplified in parts alternately or additionally to darkening of the image regions of the second type, for example with reduced contrast or schematically, for example by superimposing a texture on them or else symbolically. This is appropriate in particular for parts of the regions which are located at a relatively great distance from the roadway and are therefore irrelevant in any case for estimation of a potential hazard by the driver of the vehicle.

Within the scope of the manipulation of the image data, the image regions of the second type can also be simplified in that the sharpness of the image and/or the intensity in these image regions are adapted. By adapting the sharpness of the image and/or the intensity, the information in the image regions of the second type is advantageously reduced. The image contrast preferably remains unchanged here. In this context, further methods for adapting the image information, such as for example what is referred to as the tone mapping method or contrast masking method, are already known, for example, from digital image processing.

Furthermore it is possible for the image data of the image regions of the second type to be manipulated in terms of their color, and/or for them to be displayed with a gentle transition in their color profiles or brightness profiles, without clearly defined boundaries with the image regions of the first type. As a result of such coloring, the regions of the second type which are not of interest are distinguished clearly from the objects in the regions of the first type which are of interest, as a result of which the user can quickly and particularly reliably identify the objects contained in the image data.

FIG. 3 shows a further particularly advantageous refinement of the invention. Here, the image data from the image regions of the second type which are to be assigned to further identified objects (4, 5) were assigned to a third type of region. As indicated here, the further objects can be, for example, vehicles (4, 5). It is therefore possible to improve further an image display which is primarily specified for the visualization of pedestrians (2, 3) by virtue of the fact that other objects, here vehicles, can also be additionally identified and displayed separately in image regions of the third type. As shown in FIG. 3, in addition to the highlighted image regions of the first type the vehicles (4, 5) which are contained in the image regions of the third type are also additionally represented. It therefore becomes possible to display clearly, in the image regions of the first type, not only the objects which are to be highlighted but also further objects, which may possibly be relevant, on the image display. However, it is appropriate here to manipulate the objects in the image regions of the third type in a different way, in particular in order to avoid unnecessarily attenuating the effect of highlighting the image data of the objects in the image regions of the first type. In one preferred refinement in which the image regions of the first type are made brighter and the image regions of the second type are reduced in terms of their intensity, the image regions of the third type could be represented with the intensity which was originally captured by the camera so that an easily perceptible, three-stage intensity grouping is produced in the image.

There is also the possibility that the image data of the image regions of the third type are manipulated in terms of their color, and/or in that they are displayed with a gentle transition in their color profiles or brightness profiles, without clearly defined boundaries with the image regions of the first type and/or of the second type. It is appropriate here to select the color in such a way that, on the one hand, the image regions are clearly differentiated from the image regions of the second type and, on the other hand, the highlighting of the image data of the objects in the image regions of the first type is not unnecessarily attenuated.

As an advantageous alternative to the direct manipulation of the image data which is to be assigned to the image regions of the first type, in the sense of brightening or the like, it is certainly also conceivable to make use of the data from other sensors or sensor streams and to substitute them for the image data originally supplied by the camera of the image display system. In this way it would be possible, for example, to replace some of the image data of an infrared camera by the image data of a color camera which is also located in the vehicle. This can be highly advantageous in particular if the objects which are to be highlighted are traffic light systems. Here, the highlighting of the traffic lights could be carried out in the “black/white” data of the infrared camera by replacing the image data in the image regions of the first type with colored image information from a color camera. Since the image regions of the first type contain both the relevant objects (traffic lights here) as well as their direct surroundings, it is not particularly critical if jumps or distortions occur in the image display of the traffic scene owing to parallax errors between the two camera systems at the transitions between the image regions of the first type and the image regions of the second type. Alternatively, it would, for example, certainly also be conceivable to replace an image region of the first type in an infrared image with a conditioned information item from a radar system, in particular a high-resolution (image-generating) radar system.

In a particular way it is also conceivable for the image display to be assigned a camera which acquires image information both in the visual wavelength range and in the infrared wavelength range, in particular in the near infrared wavelength range. In this context it is then also conceivable for this camera to acquire image data from weighted portions of the visible and of the infrared wavelength range, or for the image data acquired by the camera to be subsequently subjected to weighting, and in this way it would be possible, for example, to attenuate the image data in the visual blue/green range.

The image representation in FIG. 4 is based on a special refinement of the object identification device which has already been previously described. Here, the object identification device was used to select both persons (2, 3) and another object (5) which is located directly in front of the driver's own vehicle, here likewise a vehicle, as objects to be highlighted. From FIG. 4 it is apparent that the surrounding region (2a, 3a, 4a) which is respectively assigned to the objects (2, 3, 4, 5) in the image regions of the first type can be selected differently in the form of its outline. For example, the surrounding regions 2a and 3a have an elliptically shaped outline, while the directly surrounding region (4a) which is assigned to the vehicle 4 is adapted in its outline essentially to the shape of the object. Of course, any other types of outlines are conceivable, in particular round ones or rectangular ones, on an application-specific basis.

It is also conceivable, for the purpose of highlighting the relevant objects contained in the traffic scene, to manipulate the image data of the image regions of the first type in terms of that color. This may take the form, on the one hand, of simple coloring, in particular of a change in color to yellow or red color tones. However, on the other hand it is certainly possible to configure the color profiles or brightness profiles of the image data in such a way that a gentle transition, without clearly defined boundaries with the image regions of the second type, is produced. Such manipulation of the image data is appropriate, in particular, in the case of image regions of the first type in which the image data have been derived from other sensors or sensor streams.

The image regions of the first type are particularly clearly highlighted in the image data (1) if these image regions are displayed in a flashing or pulsating manner. In this context it is conceivable to configure the frequency of the flashing or pulsation as a function of a potential hazard which the objects to be highlighted represent, in particular also as a function of their distance or their relative speed with respect to the driver's own vehicle.

The manipulation of the image data in the image regions of the first type can advantageously be carried out in such a way that the highlighting of these regions in the displayed image data (1) varies in terms of their perceptibility over time. As a result, it is possible, for example, to ensure that image regions which are assigned to newly identified objects are first only weakly highlighted and then are clearly highlighted with the progressive duration of the identification. In this way, identification errors in the identification of objects within the image data recorded by the camera have only insignificant effects since the initial weak highlighting of objects which are incorrectly detected in this way does not unnecessarily distract the driver of the vehicle.

Generally it is advantageous if the highlighting of the image regions of the first type is selected and/or varied as a function of parameters of the object (2, 3, 4, 5) contained in the image region. It is conceivable here, for example, to use those parameters of an object (2, 3, 4, 5) which describe its distance, the risk potential which it represents or its object type. It would therefore be conceivable to use red tones to color image regions in which objects are represented which are moving quickly toward the driver's own vehicle. Alternatively, image regions in which distant objects are represented could be provided with weak coloring. It would also be possible, for example, to color image regions which are to be highlighted and which contain persons with a different color tone from that of regions with vehicles in order therefore to promote the intuitive perception of objects.

Furthermore it is advantageous if the highlighting of the image regions of the first type is selected as a function of the object identification, wherein at least one parameter is evaluated which describes the reliability and/or quality of the object identification. The at least one parameter is supplied by the identifier unit or the classifier by means of which the object identification is carried out. For example, a classifier supplies, at its outputs, a standardized measure which describes the reliability or quality of identification. In this context, a greater degree of highlighting is preferably selected as the reliability or quality of identification increases.

It is also advantageous if the highlighting of the image regions of the first type is based on an increase in the size of these image regions. An object (2, 3, 4, 5) which is contained in the image region of the first type is therefore displayed in a larger form, in the same way as when it is viewed through a magnifying glass. As a result, objects (2, 3, 4, 5) can be perceived particularly easily. In this context, there is also the possibility that either only the respective image region which contains an object (2, 3, 4, 5) is displayed in a larger form, or else that the respective image region of the first type and its assigned surrounding region or regions (2a, 3a, 4a) are displayed in a larger form.

The highlighting of image regions of the first type is advantageously carried out by means of a virtual illumination source with which the objects (2, 3, 4, 5) are illuminated. Such virtual illumination sources are used on a standard basis, for example, in conjunction with graphics programs, in which case both the type of illumination source and in addition numerous illumination parameters can be selected. In this context, the illumination position and/or the illumination direction can be freely selected, for example by the user inputting values. It is also possible for the light beam or the actual light lobe which can be seen, for example, in the context of a conventional illumination source in fog, to be represented. As a result, the light beam or the light lobe indicates the direction of the respective object (2, 3, 4, 5) to the user, as a result of which the objects (2, 3, 4, 5) can be particularly easily captured in the displayed images.

In a further advantageous manner, the highlighting of the image regions of the first type is carried out in such a way that shadows which occur at objects (2, 3, 4, 5) are represented. As a result of the illumination of the objects (2, 3, 4, 5) with a virtual illumination source, shadows are produced in the virtual 3D space as a function of the virtual illumination position. These shadows are advantageously projected into the 2D representation of the image data (1) on the display unit, and as a result an impression of a 3D representation is produced with the 2D representation.

The highlighting of the image regions of the first type is carried out in a preferred refinement of the invention in such a way that only some of the objects (2, 3, 4, 5) are highlighted. For example, when persons are represented, highlighting is carried out only in the region of the legs. As a result, the representation, in particular in complex surroundings, is simplified and can therefore be displayed more clearly.

In one particular manner it is certainly conceivable that the displaying of the image regions of the second type is selected or varied as a function of the identification of an object in the image region of the first type. In this context it is, for example, conceivable to select and/or to vary the representation as a function of parameters of this identified object (2, 3) which describe its distance, the risk potential which it represents or its object type.

In particular, when an object (2, 3) is identified in a first image region, the second image region should be displayed in a darkened manner. In this context it is particularly advantageous if this darkening is carried out in a plurality of stages, in particular two or three. It is therefore possible for the incremental darkening to be coupled, in particular, to a parameter which describes an object (2, 3) identified in a first image region, such as for example the risk potential which it represents.

If the vehicle which is provided with the image display according to the invention is moving along the roadway, its dynamic behavior is frequently subject to relatively rapid changes (shaking and bouncing), in particular due to unevenesses in the roadway. As a result of the rigid coupling between the camera and body of the vehicle, the rapid dynamic changes cause “bouncing” of the representation of the image on the display. If the image data recorded by a camera are displayed in an unchanged fashion on the display, this “bouncing” is not perceived particularly clearly. However, if objects or entire object regions are then displayed highlighted in the representation of the image, this can have an extremely disruptive effect on the driver, in particular when these regions are made brighter on a display in the darkened interior of the vehicle. For this reason, in one advantageous refinement of the invention, in the highlighted image regions of the first type the surrounding region (2a, 3a, 4a) which is respectively assigned to the objects (2, 3, 4, 5) which are to be highlighted is selected in terms of its position with respect to the assigned object in a way which can vary over time in such a way that the positions of the image regions in the representation of the image data (1) on the display change only slowly.

The image regions of the first type are defined by the object (2, 3, 4, 5) located therein and the directly adjoining surrounding region (2a, 3a, 4a). If an object which is to be highlighted is temporarily no longer identified in the cases in which the object identification in the image data acquired by the camera within the scope of tracking of an object, this would inevitably lead to the function of the highlighted representation of the corresponding image region of the first type. However, this is generally not desirable since, in particular in poor light conditions, it is always necessary to expect temporary non-identification of an object which is in fact present. Resulting activation and deactivation of the highlighting of a corresponding image region of the first type would, however, have an extremely disruptive effect on the viewer.

For this reason, the invention provides, in a particularly advantageous development, that if an object (2, 3, 4, 5) which is potentially represented in an image region of the first type can no longer be identified by the object identification device when said image region of the first type is displayed highlighted in the image data (1), a highlighted display of this image region is, nevertheless, continued during a specific time period. If, in the meantime, it is then again possible for the object identification device to identify the object again, this results in essentially disruption-free continuation of the highlighting. The viewer will simply perceive that for a brief time an object cannot be identified in the highlighted image region, but this does not continue to be disruptive since the object can possibly still be perceived faintly.

Then, if an object which has been identified earlier cannot be identified again in the image data over a defined (relatively long) time period, it is appropriate to end the highlighting of the assigned image region of the first type and subsequently to treat this image region as an image region of the second type. In this context, the highlighting is preferably not ended abruptly but rather varied over time, so that this is perceived as a type of slow fading out of the image region.

The inventive image display is particularly advantageously connected to means for generating acoustic or haptic signals. As a result, it becomes possible, in addition to visual highlighting of image regions, to indicate relevant objects in the area surrounding the vehicle.

In an advantageous way, the invention is suitable for improving the vision of the driver of a vehicle at night (night vision system) in a driver assistance system, for which purpose a camera which is sensitive in the infrared wavelength range is preferably used for the recording of the image. On the other hand, advantageous use within the scope of a driver assistance system for improving for improved perception of relevant information in town center situations (town center assistant) is also certainly conceivable, in which case in particular traffic light systems and/or road signs are highlighted as relevant objects here.

When the invention is used within the scope of a driver assistance system, it is appropriate, on the one hand, to embody the image display as a head-up display, but, on the other hand, it is also advantageous to mount the display in the dashboard region located directly in front of the driver of the vehicle, since the driver only has to briefly look down in order to view the display.

1. A method for displaying images,
in which image data from the area surrounding a vehicle are recorded by means of a camera,
in which objects (2, 3, 4, 5) in the recorded image data are identified by means of an object identification device,
and in which at least some of the image data (1) are at least partially displayed on a display,
wherein at least some of the identified objects (2, 3, 4, 5) are highlighted in the image data (1),
wherein the highlighting of the identified objects (2, 3, 4, 5) is carried out in such a way
that the displayed image data (1) are divided into two types of region,
wherein the first type of region comprises the identified objects (2, 3, 4, 5) which are to be highlighted and a surrounding region (2a, 3a, 4a) which respectively directly adjoins said objects in a corresponding manner,
and wherein the second type of region comprises those image data (1) which have not been assigned to the first type of region,
and in that the image data of the two types of region are manipulated in different ways.

2. The method as claimed in claim 1,
wherein within the scope of the manipulation of the image data, the image regions of the first type are made brighter.

3. The method as claimed in claim 1,
wherein within the scope of the manipulation of the image data, the image regions of the second type are made darker, or least some of said image regions are simplified or replaced by schematic or symbolic representations.

4. The method as claimed in claim 1,
wherein within the scope of the manipulation of the image data, the image regions of the second type are simplified in that the sharpness of the image and/or the intensity in these regions are adapted.

5. The method as claimed in claim 1,
wherein the image data of the image regions of the second type are manipulated in terms of their color,
and/or in that they are displayed with a gentle transition in their color profiles or brightness profiles, without clearly defined boundaries with the image regions of the first type.

6. The method as claimed in claim 1,
wherein the image data of the second type of region which are to be assigned to identified objects (2, 3, 4, 5) are assigned to a third type of region,
and in that the image data of this third type of region are manipulated differently from the image data of the second type of region.

7. The method as claimed in claim 6,
wherein the image data of the image regions of the third type are not subjected to manipulation.

8. The method as claimed in claim 6,
wherein the image data of the image regions of the third type are manipulated in terms of their color,
and/or in that they are displayed with a gentle transition in their color profiles or brightness profiles, without clearly defined boundaries with the image regions of the first type and/or of the second type.

9. The method as claimed in claim 1,
wherein within the scope of the manipulation of the image data, the image data of the regions of the first type are replaced by the corresponding image data of another sensor or of another sensor stream.

10. The method as claimed in claim 1
wherein the surrounding region (2a, 3a, 4a) which is respectively assigned to the objects (2, 3, 4, 5) in the image regions of the first type is selected with its outline adapted elliptically or in a circular manner or to the shape of the object.

11. The method as claimed in claim 1,
wherein the image data of the image regions of the first type are manipulated in terms of their color,
and/or in that they are displayed with a gentle transition in their color profiles or brightness profiles, without clearly defined boundaries with the image regions of the second type.

12. The method as claimed in claim 1,
wherein the image data of the image regions of the first type are displayed in a flashing or pulsating manner.

13. The method as claimed in claim 1,
wherein the manipulation of the image data in the image regions of the first type is carried out in such a way that the highlighting of these regions in the displayed image data (1) varies in terms of their perceptibility over time.

14. The method as claimed in claim 10,
wherein the variation over time occurs in such a way that the perceptibility of the highlighting increases with the progressive duration of the identification of the object (2, 3, 4, 5) contained in the image region.

15. The method as claimed in claim 1,
wherein the highlighting of the image regions of the first type is selected and/or varied as a function of parameters of the object (2, 3, 4, 5) contained in the image region, wherein the parameters describe the distance of the object (2, 3, 4, 5) or the risk potential which it represents or its object type.

16. The method as claimed in claim 1
wherein the highlighting of the image regions of the first type is selected as a function of the object identification,
wherein at least one parameter is evaluated which describes the reliability and/or quality of the object identification.

17. The method as claimed in claim 1,
wherein the highlighting of the image regions of the first type is based on an increase in the size of these image regions.

18. The method as claimed in claim 1
wherein the highlighting of image regions of the first type is carried out by means of a virtual illumination source with which objects (2, 3, 4, 5) are illuminated.

19. The method as claimed in claim 18,
wherein the highlighting of the image regions of the first type is carried out in such a way that shadows which occur at objects (2, 3, 4, 5) are represented.

20. The method as claimed in claim 1,
wherein the highlighting of the image regions of the first type is carried out in such a way that only some of the objects (2, 3, 4, 5) are highlighted.

21. The method as claimed in claim 1,
wherein the displaying of the image regions of the second type is selected or varied as a function of the identification of objects in image regions of the first type.

22. The method as claimed in claim 21,
wherein the image data of the image regions of the second type are displayed in a darkened manner.

23. The method as claimed in claim 22,
wherein the darkening is carried out in a plurality of stages as a function of a parameter of the object identified in the first image region.

24. The method as claimed in claim 1,
wherein the surrounding region (2a, 3a, 4a) which is to be assigned to the respective objects (2, 3, 4, 5) in the image regions of the first type is selected in terms of its position with respect to the assigned object in a way which can vary over time in such a way that the positions of the image regions in the representation of the image data (1) on the display change only slowly.

25. The method as claimed in claim 1,
wherein if an object (2, 3, 4, 5) which is potentially represented in an image region of the first type can no longer be identified by the object identification device when said image region of the first type is displayed highlighted in the image data (1), a highlighted display of this image region is continued during a specific time period.

26. The method as claimed in claim 25,
wherein if the object identification device still cannot identify an object (2, 3, 4, 5) in the image region after the expiry of the time period, the highlighting of the image region is ended and the image region is subsequently treated as an image region of the second type.

27. The method as claimed in claim 26,
wherein the ending of the highlighting occurs with variation over time.

28. An image display comprising a camera for recording image data from the area surrounding a vehicle,
comprising an object identification device for identifying objects (2, 3, 4, 5) in the recorded image data,
and comprising a display for displaying at least parts of the recorded image data,
wherein an image processing device is provided which manipulates the image data in such a way that at least some of said data are displayed highlighted on the display,
wherein the image display comprises a means for dividing the image data at least into two types of region,
wherein the first type of region comprises the identified objects (2, 3, 4, 5) which are to be highlighted and the surrounding region (2a, 3a, 4b) which respectively directly adjoins said objects in a corresponding manner,
and wherein the second type of region comprises those image data (1) which have not been assigned to the first type of region.

29. The image display as claimed in claim 28,
wherein the camera acquires image data from the infrared wavelength range.

30. The image display as claimed in claim 28,
wherein the camera acquires image data from weighted portions of the visible and of the infrared wavelength range.

31. The image display as claimed in claim 28
wherein the image display is a display which is located in the dashboard region of the vehicle.

32. The image display as claimed in claim 28,
wherein the image display is connected to means for generating acoustic or haptic signals, which means can, in addition to visual highlighting of image regions, indicate the presence of relevant objects in the area surrounding the vehicle through further signaling.

33. The use of the image display or of the method for displaying images as claimed in claim 1 as a driver assistance system for improving the vision of the driver of a vehicle at night (night vision system).

34. The use of the image display or of the method for displaying images as claimed in claim 1 as a driver assistance system for improving for improved perception of relevant information in town center situations (town center assistant).
